(19) United States
(12) Patent Application Publication
(10) Pub. No.: US 2025/0091936 A1
(43) Pub. Date: Mar. 20, 2025

(54) Fluorescent Glass With High Content Of Cerium And Tin

(71) Applicant: Ivoclar Vivadent AG, Schaan (LI)

(72) Inventors: Marc Dittmer, Feldkirch (AT); Markus Rampf, Seewis Dorf (CH); Christian Ritzberger, Grabs (CH)

(21) Appl. No.: 18/890,581

(22) Filed: Sep. 19, 2024

(30) Foreign Application Priority Data
Sep. 20, 2023 (EP) 23198558.1

(51) Int. Cl. C03C 4/12; A61C 13/083; C03B 5/235; C03C 3/118; C03C 4/00; C03C 8/06; C03C 10/00

(52) U.S. Cl. CPC C03C 4/12; A61C 13/0835; C03B 5/235; C03C 3/118; C03C 4/0021; C03C 8/06; C03C 10/0054; C03C 2204/00; C03C 2205/06

(57) ABSTRACT

Glasses with high content of cerium and tin including the following components:

| Component | Wt. - % |
|---|---|
| SiO₂ | 38.0 to 68.0 |
| Cerium, calculated as CeO₂ | 4.0 to 23.0 |
| Tin, calculated as SnO | 3.0 to 18.0 |
| Li₂O | 1.0 to 5.0 |
| Alkali metal oxide Me^{I}₂O | 5.8 to 15.9 |
| Oxide of divalent elements Me^{II}O | 3.2 to 10.5 |
| Oxide of trivalent elements Me^{III}₂O₃ | 3.5 to 11.8 |

and which are particularly suitable for the preparation of dental restorations whose fluorescence properties largely correspond to those of natural teeth.

### CROSS-REFERENCE TO RELATED APPLICATIONS

This application claims priority to European Patent Application No. 23198558.1 filed on Sep. 20, 2023, the disclosure of which is incorporated herein by reference in its entirety.

### TECHNICAL FIELD

The present invention relates to glass which has a high content of cerium and tin and is particularly suitable for the preparation of dental restorations whose fluorescence properties largely correspond to those of natural teeth. The invention also relates to a process for preparing the glass according to the invention, a process for preparing dental restorations, and the use of the glass according to the invention as a mixing component and as a dental material, in particular as a coating material for preparing dental restorations.

### BACKGROUND

Glasses are used in dentistry because of their good optical properties, particularly for coating other materials, e.g. as stain or glazing material.

Various approaches are known to reproduce the fluorescence properties of natural teeth in glasses and, where appropriate, glass ceramics made from them in the preparation of dental restorations.

EP 2 944 619 A1 and corresponding U.S. Ser. No. 10/737,972B2, which US patent is incorporated by reference in its entirety, describe a process for the preparation of fluorescent lithium silicate glasses. The process involves subjecting the melt of a starting glass containing cerium ions to reducing conditions. The reducing conditions are provided by the use of a reducing agent, which is preferably a gaseous reducing agent or selected from the group consisting of organic salts, carbohydrates and cereal flours.

WO 2017/032745 A1 and corresponding U.S. Ser. No. 10/501,366 B2, which US patent is incorporated by reference in its entirety, describe lithium silicate low quartz glass ceramics for use in dentistry. The glass ceramics may contain colorants and fluorescent agents preferably selected from Bi₂O₃ and Bi₂O₅ and inorganic pigments and/or oxides of d and f elements, such as the oxides of Mn, Fe, Co, Pr, Nd, Tb, Er, Dy, Eu and Yb.

From EP 3 696 150 A1 and corresponding U.S. Ser. No. 11/440,834 B2, which US patent is incorporated by reference in its entirety, glasses containing 0.05 to 5.0 wt.-% europium, calculated as Eu₂O₃, are known to impart advantageous fluorescence properties to dental restorations made from the glasses.

From W. Buchalla, “Comparative Fluorescence Spectroscopy Shows Differences in Non-Cavitated Enamel Lesions,” Caries Res. 2005, 39, 150-156, it is known that natural teeth show bluish-white fluorescence under ultraviolet light with wavelengths ranging from 400 to 650 nm.

EP 3 696 149 A1 and corresponding U.S. Ser. No. 11/440,833 B2, which US patent is incorporated by reference in its entirety, describe glasses and glass ceramics containing cerium and tin which fluoresce when excited with light of a wavelength of 365 nm. However, when excited with light of a wavelength of 395 nm, the glasses and glass ceramics described do not show any fluorescence.

It has been shown that the glasses known from the prior art have insufficient fluorescence properties and cannot sufficiently imitate the fluorescence properties of the natural tooth material, particularly under light with a wavelength of about 380 to 430 nm. In particular, there is a need for glasses that also exhibit good fluorescence properties in the particularly long-wave UV range, such as 380 to 430 nm. Light of these wavelengths is often used as “black light” in entertainment venues such as nightclubs. There, therefore, dental restorations with insufficient fluorescence properties may be recognizable as restorations under the influence of long-wave UV light or may be perceived as tooth gaps or defects.

### SUMMARY

The invention is based on the problem of providing glass which exhibits fluorescence comparable to that of natural dental material and is thus particularly suitable for the preparation of dental restorations which can largely imitate the fluorescence properties of natural dental material at excitation wavelengths in the long-wave UV range, such as 380 to 430 nm and in particular 395 nm. The glass should also be suitable as mixing component for adjusting the fluorescence properties of other glasses.

This problem is solved according to the invention by a glass containing cerium and tin, as well as a glass and a glass ceramic, which contain the glass according to the invention. The invention also relates to the use of the glasses according to the invention. In addition, the invention is directed to a process for preparing the glasses according to the invention and a coating process using the glasses according to the invention.

### BRIEF DESCRIPTION OF THE DRAWINGS

Exemplary embodiments of the invention are shown in the drawings and are described in more detail below, in which:

FIG. 1 shows a comparison of glass bodies when irradiated with a UV LED.

### DETAILED DESCRIPTION

The invention relates to a glass containing cerium and tin, characterized in that it comprises the following components in the amounts indicated:

| Component | Wt.-% |
|---|---|
| SiO₂ | 38.0 to 68.0 |
| Cerium, calculated as CeO₂ | 4.0 to 23.0 |
| Tin, calculated as SnO | 3.0 to 18.0 |
| Li₂O | 1.0 to 5.0 |
| Alkali metal oxide Me^{I}₂O | 5.8 to 15.9 |
| Oxide of divalent elements Me^{II}O | 3.2 to 10.5 |
| Oxide of trivalent elements Me^{III}₂O₃ | 3.5 to 11.8, |

wherein
Me^{I}₂O is selected from Na₂O, K₂O, Rb₂O, and/or Cs₂O,
Me^{II}O is selected from MgO, CaO, SrO, BaO and/or ZnO,
Me^{III}₂O₃ is selected from Al₂O₃, B₂O₃, Y₂O₃, La₂O₃, Dy₂O₃, Ga₂O₃ and/or In₂O₃.

Surprisingly, it has been shown that the glass according to the invention exhibits improved fluorescence properties compared to the prior art, particularly when exposed to UV light with a wavelength of 380 to 430 nm, such as 395 nm. It has been found in the context of the present invention that the use of higher amounts of cerium and tin than known in the prior art causes the fluorescence properties of glasses to change. In particular, it has been shown that by using higher proportions of cerium and tin, a clearly visible fluorescence can be obtained even when excited with light having a wavelength of 380 to 430 nm. The glasses according to the invention have therefore proven to be particularly suitable for imitating natural tooth material.

Without limitation to any particular theory, it is assumed that the use of larger amounts of cerium and tin changes the fluorescence properties of Ce³⁺ ions and shifts the excitation spectrum, so that clear fluorescence can also be perceived in glasses when excited with light of a wavelength in the range from 380 to 430 nm, such as 395 nm. The high intensity of fluorescence observed in the glasses according to the invention when excited with light of a wavelength of 380 to 430 nm is surprising because the glasses known in the prior art, such as in particular the glasses described in EP 3 696 149 and corresponding U.S. Ser. No. 11/440,833 B2, which is hereby incorporated by reference in its entirety, do not exhibit any perceptible fluorescence when excited in this way.

The glass according to the invention preferably contains 4.3 to 22.0, in particular 4.7 to 21.5 and particularly preferably 5.3 to 21.0 wt.-% cerium, calculated as CeO₂.

It is also preferred that the glass contains 3.4 to 17.2, in particular 3.7 to 16.9, and particularly preferred 4.1 to 16.4 wt.-% tin, calculated as SnO.

Also preferred according to the invention is a glass in which the molar ratio of cerium, calculated as CeO₂, to tin, calculated as SnO, is in the range of 1.5:1 to 1:5, in particular 1.2:1 to 1:1.2, more preferably 1.1:1 to 1:1.1, and particularly preferably is 1.0:1.0.

According to the invention, it is also preferred that the glass contains 40.0 to 65.0 and particularly preferred 42.0 to 62.0 wt.-% SiO₂.

It is also preferred that the glass contains 1.4 to 4.0 and more preferably 1.9 to 3.1 wt.-% Li₂O.

In another preferred embodiment, the glass contains 0.4 to 2.4, in particular 0.6 to 1.9, and particularly preferably 0.8 to 1.6 wt.-% fluorine.

In a preferred embodiment, the glass contains 6.9 to 14.7 and in particular 7.7 to 13.9 wt.-% of alkali metal oxide Me^{I}₂O, wherein Me^{I}₂O is selected from Na₂O, K₂O, Rb₂O and/or Cs₂O and in particular from Na₂O and/or K₂O.

Preferably, the glass according to the invention contains at least one and in particular all of the following alkali metal oxides Me^{I}₂O in the amounts indicated:

| Component | Wt. - % |
|---|---|
| K₂O | 2.0 to 7.9 |
| in particular | 2.5 to 7.3 |
| particularly preferred | 2.9 to 6.9 |
| Na₂O | 3.8 to 8.0 |
| in particular | 4.4 to 7.4 |
| particularly preferred | 4.8 to 7.0 |

In a further preferred embodiment, the glass contains 4.2 to 8.8 and in particular 5.1 to 7.7 wt.-% oxide of divalent elements Me^{II}O, wherein Me^{II}O is selected from MgO, CaO, SrO, BaO and/or ZnO and preferably from MgO, CaO, SrO and/or ZnO.

It is particularly preferred that the glass contains at least one and particularly all of the following oxides of divalent elements Me^{II}O in the amounts indicated:

| Component | Wt. - % |
|---|---|
| CaO | 0.8 to 2.5 |
| in particular | 1.0 to 2.0 |
| particularly preferred | 1.2 to 1.7 |
| SrO | 1.0 to 3.0 |
| in particular | 1.3 to 2.6 |
| particularly preferred | 1.6 to 2.3 |
| ZnO | 1.4 to 4.0 |
| in particular | 1.9 to 3.6 |
| particularly preferred | 2.3 to 3.3 |
| MgO | 0 to 1.0 |
| preferably | 0 to 0.6 |
| in particular | 0 to 0.4 |
| particularly preferably | 0.1 to 0.4 |

It is also preferred that the glass contains 4.1 to 10.9 and in particular 4.8 to 10.0 wt.-% oxide of trivalent elements Me^{III}₂O₃, wherein Me^{III}₂O₃ is selected from Al₂O₃, B₂O₃, Y₂O₃, La₂O₃, Dy₂O₃, Ga₂O₃ and/or In₂O₃ and preferably from Al₂O₃ and/or B₂O₃.

In a particularly preferred embodiment, the glass contains at least one and in particular all of the following oxides of trivalent elements Me^{III}₂O₃ in the amounts indicated:

| Component | Wt. - % |
|---|---|
| Al₂O₃ | 2.5 to 7.3 |
| in particular | 2.8 to 6.8 |
| particularly preferred | 3.2 to 6.3 |
| B₂O₃ | 1.0 to 4.5 |
| in particular | 1.3 to 4.1 |
| particularly preferably | 1.6 to 3.7 |

It is also preferred that the glass further contains from 0.1 to 3.4, in particular 0.2 to 2.6, and more preferably 0.4 to 2.0 wt.-% oxide of tetravalent elements Me^{IV}O₂, wherein Me^{IV}O₂ is selected from ZrO₂, TiO₂ and/or GeO₂ and preferably from ZrO₂ and/or TiO₂.

Particularly preferably, the glass contains at least one and particularly all of the following oxides of tetravalent elements Me^{IV}O₂ in the amounts indicated:

| Component | Wt. - % |
|---|---|
| TiO₂ | 0 to 2.2 |
| in particular | 0 to 1.7 |
| particularly preferred | 0.1 to 1.4 |
| ZrO₂ | 0 to 1.2 |
| preferably | 0.1 to 1.2 |
| in particular | 0.2 to 0.9 |
| particularly preferably | 0.4 to 0.6 |

In a preferred embodiment, the glass further comprises oxide of pentavalent elements Me^{V2}O₅ in an amount of 0 to 10.0, in particular 0 to 8.0, preferably 1.0 to 7.0, more preferably from 2.0 to 6.8 and particularly preferably from 3.0 to 6.5 wt.-%, wherein this Me^{V2}O₅ is selected in particular from P₂O₅, Ta₂O₅ and/or Nb₂O₅ and particularly preferably from P₂O₅ and/or Ta₂O₅.

According to the invention, it is preferred that the glass contains at least one and preferably all of the following components in the amounts indicated:

| Component | Wt. - % |
|---|---|
| SiO₂ | 38.0 to 68.0 |
| Cerium, calculated as CeO₂ | 4.0 to 23.0 |
| Tin, calculated as SnO | 3.0 to 18.0 |
| Li₂O | 1.0 to 5.0 |
| Al₂O₃ | 2.5 to 7.3 |
| Na₂O | 3.8 to 8.0 |
| K₂O | 2.0 to 7.9 |
| CaO | 0.8 to 2.5 |
| SrO | 1.0 to 3.0 |
| ZnO | 1.4 to 4.0 |
| B₂O₃ | 1.0 to 4.5 |
| F | 0.4 to 2.4 |
| ZrO₂ | 0 to 1.2 |
| MgO | 0 to 1.4 |
| TiO₂ | 0 to 3.0 |

It is further preferred that the glass contains at least one, and preferably all, of the following components in the amounts indicated:

| Component | Wt. - % |
|---|---|
| SiO₂ | 40.0 to 65.0 |
| Cerium, calculated as CeO₂ | 4.3 to 22.0 |
| Tin, calculated as SnO | 3.4 to 18.0 |
| Li₂O | 1.4 to 4.0 |
| Al₂O₃ | 2.8 to 6.8 |
| Na₂O | 4.4 to 7.4 |
| K₂O | 2.5 to 7.3 |
| CaO | 1.0 to 2.0 |
| SrO | 1.3 to 2.6 |
| ZnO | 1.9 to 3.6 |
| B₂O₃ | 1.3 to 4.1 |
| F | 0.6 to 1.9 |
| ZrO₂ | 0.2 to 0.9 |
| MgO | 0 to 0.8 |
| TiO₂ | 0 to 2.0 |

In a particularly preferred embodiment, the glass contains at least one and preferably all of the following components in the amounts indicated:

| Component | Wt. - % |
|---|---|
| SiO₂ | 42.0 to 62.0 |
| Cerium, calculated as CeO₂ | 4.7 to 21.0 |
| Tin, calculated as SnO | 3.7 to 17.2 |
| Li₂O | 1.9 to 3.1 |
| Al₂O₃ | 3.2 to 6.3 |
| Na₂O | 4.8 to 7.0 |
| K₂O | 2.9 to 6.9 |
| CaO | 1.2 to 1.7 |
| SrO | 1.6 to 2.3 |
| ZnO | 2.3 to 3.3 |
| B₂O₃ | 1.6 to 3.7 |
| F | 0.8 to 1.6 |
| ZrO₂ | 0.4 to 0.6 |
| MgO | 0 to 0.4 |
| TiO₂ | 0 to 1.4 |

The invention further relates to a glass according to the invention, which exhibits a whitish-blue fluorescent color in the CIE color space when excited with light having a wavelength of 380 to 430 nm, in particular 395 nm.

The invention also relates to a process for the preparation of the glass according to the invention, in which the tin is used in divalent form and in particular as SnO.

In the preparation of the glass according to the invention, in particular a mixture of suitable starting materials, such as carbonates, oxides, phosphates and fluorides, is melted. In a preferred embodiment, the starting materials of the components of the glass are melted at a temperature of 1400 to 1700° C., in particular 1450 to 1600° C. and particularly preferably 1500° C., for preferably 20 min to 10 h.

The melt can then be added to water to produce a granulate. To achieve a particularly high homogeneity, the granules can be melted again and the melt again added to water to form a glass granulate.

It is preferred that a glass granulate is comminuted to a powder, e.g. by grinding with a zirconium oxide mill. Further components, such as colorants, can be added to this powder.

The powder can then be used to produce, for example, a powder mixture, a paste or an aerosol. The glasses according to the invention are therefore preferably in the form of granulate, powder, paste or aerosol.

The above-described glasses can also be used as a mixing component for admixture to other glasses and glass ceramics, and preferably to other glasses.

A glass and a glass ceramic containing the glass according to the invention therefore constitute a further subject matter of the invention. Particularly preferred are a glass and a glass ceramic containing the glass according to the invention with a high content of cerium and tin in an amount of 0.1 to 60 wt.-% in particular 1 to 58 wt.-%, preferably 5 to 56 wt.-%, particularly preferably 10 to 54 wt.-% and more preferred 5 to 52 wt.-%, based on the total amount of glass or glass ceramic and glass according to the invention. The invention also relates to the use of the glasses according to the invention with a high content of cerium and tin as a mixing component for adjusting the fluorescence of a glass and a glass ceramic.

The glass according to the invention with a high content of cerium and tin can be used, in particular, in combination with a variety of other glasses and glass ceramics, and the combinations can be used, in particular, as dental materials. It is preferred to use the glass of the invention in combination with other glasses. Particularly preferably, the combinations may be in the form of granulates, powders, pastes, aerosols or coatings of dental restorations.

Examples of other glasses for preparing combinations are disclosed in DE 43 14 817 A1 and corresponding U.S. Pat. No. 5,432,130 A, DE 44 23 793 C1 and corresponding U.S. Pat. No. 5,698,019 A, DE 44 23 794 C1 and corresponding U.S. Pat. No. 5,925,180 A, DE 44 28 839 A1 and corresponding U.S. Pat. No. 5,618,763 A, DE 196 47 739 A1, DE 197 25 552 A1, DE 100 31 431 A1, EP 0 827 941 A1, EP 0 916 625 A1, WO 00/34196 A2 and corresponding U.S. Pat. No. 6,455,451 B1, EP 1 505 041 A1 and corresponding U.S. Pat. No. 8,047,021 B2, EP 1 688 398 A1, EP 2 287 122 A1 and corresponding US 2011021336 A1, EP 2 377 831 A1 and corresponding U.S. Pat. No. 9,321,674 B2, EP 2 407 439 A1 and corresponding U.S. Pat. No. 9,321,674 B2, WO 2013/053863 A2 and corresponding U.S. Pat. No. 9,878,939 B2, WO 2013/053864 A2 and corresponding U.S. Pat. No. 9,776,912 B2, WO 2013/053865 A2 and corresponding U.S. Pat. No. 9,402,699 B2, WO 2013/053866 A2 and corresponding U.S. Pat. No. 9,695,082 B2, WO 2013/053867 A2 and corresponding U.S. Ser. No. 10/227,255 B2, WO 2013/053868 A2 and corresponding U.S. Pat. No. 9,403,714 B2, WO 2013/164256 A1 and corresponding U.S. Pat. No. 9,764,982 B2, WO 2014/170168 A1 and corresponding U.S. Ser. No. 10/376,343 B2, WO 2014/170170 A2 and corresponding U.S. Pat. No. 9,757,311 B2, WO 2015/067643 A1 and corresponding U.S. Pat. No. 9,688,567 B2, WO 2015/155038 A1 and corresponding U.S. Ser. No. 11/051,918 B2, WO 2015/173394 A1 and corresponding U.S. Ser. No. 11/091,388 B2, WO 2016/120146 A1 and corresponding U.S. Ser. No. 10/457,589 B2, WO 2017/032745 A1 and corresponding U.S. Ser. No. 11/325,858 B2, WO 2017/055010 A1 and corresponding U.S. Ser. No. 10/590,028 B2. The US patents and/or published applications set forth in this paragraph are hereby incorporated by reference in their entirety. These glasses belong to the silicate, borate, phosphate or aluminosilicate group. Preferred glasses are of SiO₂—Al₂O₃—K₂O-type, SiO₂—B₂O₃—Na₂O-type, alkali-silicate type, alkali-zinc-silicate type, silico-phosphate type and/or SiO₂—ZrO₂-type. Preferred glass ceramics for the admixture of the glasses of the invention for preparing combinations are apatite-containing glass ceramics. By mixing such glasses and glass ceramics with the glasses of the invention having a high content of cerium and tin, in particular the fluorescence properties can be adjusted in a desired manner.

The glass ceramics according to the invention and the glasses according to the invention, in particular in the form of combinations, are suitable for coating of, in particular, ceramics, glass ceramics and metals, for example. By “coatings” which can be produced using the glasses according to the invention and the glass ceramics according to the invention, in particular in the form of combinations, is also meant, for example, glazes.

The invention is therefore also directed to the use of the glass according to the invention and the glass ceramic according to the invention, in particular in the form of combinations, for coating of in particular ceramics, glass ceramics and metals. The coating preferably includes applying glass according to the invention or glass ceramic according to the invention, in particular in the form of combinations, to a substrate material and subjecting it together with the substrate material to a heat treatment, preferably at a temperature of at least 600° C., in particular 600 to 1150° C. and particularly preferably 700 to 1000° C.

Due to the above-described properties of the glasses according to the invention, they are particularly suitable for use in dentistry. It is therefore also an object of the invention to use the glasses according to the invention, in particular in the form of combinations, as dental material.

The glasses according to the invention, in particular in the form of combinations, can be used to coat dental restorations, in particular inlays, onlays, crowns, partial crowns, bridges, veneers, facets or abutments. The glasses according to the invention can therefore also be present as a coating of a dental restoration.

The invention also relates to the use of the glasses according to the invention for coating a dental restoration, wherein a substrate material, in particular a glass ceramic, a ceramic or a metal, is coated with the glass according to the invention.

The use for coating a dental restoration preferably comprises applying the glass according to the invention, in particular in the form of a combination, to a substrate material and subjecting it together with the substrate material to a heat treatment, preferably at a temperature of at least 600° C., in particular 600 to 1150° C. and particularly preferably 700 to 1000° C. The application of the glass according to the invention, in particular in the form of a combination, is carried out in the usual manner, for example as a powder, paste or aerosol. Preferably, the substrate material is a glass ceramic, a ceramic or a metal.

The invention is also directed to a process for coating a dental restoration, in which a substrate material, in particular a glass ceramic, a ceramic or a metal, is coated with the glass according to the invention. According to the invention, the glass may also be present in combination with a glass or glass ceramic, such as an apatite-containing glass ceramic.

The process for coating a dental restoration preferably comprises applying the glass according to the invention, in particular in the form of a combination, to a substrate material and subjecting it together with the substrate material to a heat treatment, preferably at a temperature of at least 600° C., in particular 600 to 1150° C. and particularly preferably 700 to 1000° C. The application of the glass according to the invention, in particular in the form of a combination, is carried out in the usual manner, for example as a powder, paste or aerosol. Preferably, the substrate material is a glass ceramic, a ceramic or a metal.

It is preferred that the coating of a dental restoration is performed as part of the preparation of a coated dental restoration, in particular selected from inlay, onlay, crown, partial crown, bridge, veneer, facet and abutment.

Consequently, it is a subject matter of the invention to use the glasses according to the invention in the preparation of a coated dental restoration, wherein a substrate material, in particular a glass ceramic, a ceramic or a metal, is coated with the glass according to the invention.

In addition, the invention is directed to a process for preparing a coated dental restoration, in which a substrate material, in particular a glass ceramic, a ceramic or a metal, is coated with the glass according to the invention.

The invention is explained in more detail below by means of examples which do not limit it.

### EXAMPLES

### 1. Preparation of Fluorescent Glasses

10 glasses according to the invention with the compositions given in Table I were prepared. For this purpose, starting glasses with the compositions given in Table I were first melted from common raw materials at 1500° C. for 60 min. Glass frits were prepared by pouring the molten starting glasses into water.

For glasses 1, 2, 4 and 8 according to the invention, the glass transition temperature T_{g} given in the table was determined by DSC (Differential Scanning Calorimetry).

In addition, two glasses were produced as comparative examples using a corresponding process. The compositions of these glasses are also given in Table I as Examples 11 and 12.

In deviation from the process for the preparation of the glasses of Examples 1 to 10, the melting for the preparation of Example 11 was carried out at 1650° C. for 240 min.

The fluorescence properties of the glass frits were investigated. For this purpose, the glass frits were successively irradiated with a mercury vapor lamp (excitation wavelength 365 nm) and with a UV LED (excitation wavelength 395 nm) and examined for fluorescence with the naked eye in each case.

For the glass frits of examples 1 to 10, clear fluorescence could be perceived both upon excitation with the mercury vapor lamp and upon excitation with the UV LED.

The glass frit of example 11 showed clearly perceptible fluorescence when irradiated with the mercury vapor lamp (excitation wavelength 365 nm). However, no fluorescence could be perceived when excited with the UV LED (excitation wavelength 395 nm). When examining the glass frit of Example 12, no fluorescence was observed either when irradiated with the mercury vapor lamp or when irradiated with the UV LED.

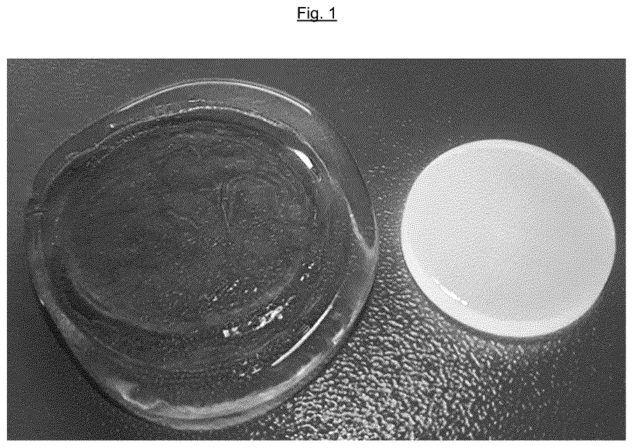

The glass frit of Example 2 was ground to a grain size of 45 μm in a zirconium oxide mill and sintered at 760° C. for a holding time of 1 min. The glass body thus obtained showed a clearly perceptible whitish-blue fluorescence when irradiated with the UV LED (excitation wavelength 395 nm). This is also illustrated by the photograph shown as FIG. 1. The body shown on the right in FIG. 1 is the fluorescent glass body when irradiated with the UV LED.

For comparison, a solid glass sheet was made from the glass frit of Example 11 by using the process described in EP 3 696 149 A1 and corresponding U.S. Ser. No. 11/440,833 B2, which is hereby incorporated by reference in its entirety, for its Example 5. The process involved remelting the glass frit of Example 11 at 1650° C. for 240 min. The resulting melt was then poured onto a copper block to produce a solid glass sheet. This solid glass sheet was then examined for its fluorescence when irradiated with the UV LED (excitation wavelength 395 nm). The results are also illustrated by FIG. 1. The left body in FIG. 1 is the solid glass sheet obtained, which shows no fluorescence when irradiated with the UV LED.

TABLE 1

| | Example | | | | | |
|---|---|---|---|---|---|---|
| | 1 | 2 | 3 | 4 | 5 | 6 |
| Composition | Wt.-% | Wt.-% | Wt.-% | Wt.-% | Wt.-% | Wt.-% |
| SiO₂ | 60.5 | 56.2 | 53.5 | 50.8 | 48.4 | 46.2 |
| CeO₂ | 4.1 | 7.9 | 10.2 | 12.4 | 14.5 | 16.4 |
| SnO | 3.2 | 6.1 | 8.0 | 9.7 | 11.3 | 12.9 |
| Al₂O₃ | 4.7 | 4.3 | 4.1 | 3.9 | 3.8 | 3.6 |
| P₂O₅ | — | — | — | — | — | — |
| Li₂O | 3.1 | 2.9 | 2.7 | 2.6 | 2.5 | 2.4 |
| Na₂O | 7.0 | 6.5 | 6.1 | 5.9 | 5.6 | 5.3 |
| K₂O | 4.2 | 3.9 | 3.7 | 3.6 | 3.4 | 3.2 |
| MgO | 0.4 | 0.4 | 0.4 | 0.4 | 0.3 | 0.3 |
| CaO | 1.7 | 1.6 | 1.5 | 1.4 | 1.3 | 1.3 |
| SrO | 2.3 | 2.1 | 2.0 | 1.9 | 1.8 | 1.7 |
| ZnO | 3.3 | 3.0 | 2.9 | 2.7 | 2.6 | 2.5 |
| B₂O₃ | 3.7 | 3.5 | 3.3 | 3.2 | 3.0 | 2.9 |
| F− | 1.2 | 1.1 | 1.1 | 1.0 | 1.0 | 0.9 |
| TiO₂ | — | — | — | — | — | — |
| ZrO₂ | 0.6 | 0.5 | 0.5 | 0.5 | 0.5 | 0.4 |
| Σ | 100.0 | 100.0 | 100.0 | 100.0 | 100.0 | 100.0 |
| T_{g} [° C.] | 468.5 | 494.4 | — | 528.8 | — | — |
| | Example | | | | | |
| | 7 | 8 | 9 | 10 | 11* | 12* |
| Composition | Wt.-% | Wt.-% | Wt.-% | Wt.-% | Wt.-% | Wt.-% |
| SiO₂ | 44.1 | 42.0 | 60.3 | 61.2 | 63.7 | 64.9 |
| CeO₂ | 18.3 | 20.1 | 4.0 | 4.0 | 7.3 | 0.6 |
| SnO | 14.3 | 15.7 | 3.1 | 3.2 | 2.8 | — |
| Al₂O₃ | 3.4 | 3.2 | 6.2 | 6.3 | 5.4 | 5.0 |
| P₂O₅ | — | — | — | — | — | — |
| Li₂O | 2.2 | 2.1 | 1.9 | 2.0 | 15.8 | 3.3 |
| Na₂O | 5.1 | 4.8 | 6.3 | 6.4 | — | 7.5 |
| K₂O | 3.1 | 2.9 | 6.8 | 6.9 | 5.0 | 4.6 |
| MgO | 0.3 | 0.3 | — | — | — | 0.6 |
| CaO | 1.2 | 1.2 | 1.2 | 1.2 | — | 1.8 |
| SrO | 1.6 | 1.6 | 2.1 | 2.1 | — | 2.4 |
| ZnO | 2.4 | 2.3 | 2.9 | 2.9 | — | 3.5 |
| B₂O₃ | 2.7 | 2.6 | 1.6 | 1.6 | — | 4.0 |
| F− | 0.9 | 0.8 | 1.6 | 1.6 | — | 1.3 |
| TiO₂ | — | — | 1.4 | — | — | — |
| ZrO₂ | 0.4 | 0.4 | 0.6 | 0.6 | — | 0.6 |
| Σ | 100.0 | 100.0 | 100.0 | 100.0 | 100.0 | 100.0 |
| T_{g} [° C.] | — | 533.3 | — | — | — | — |

*Comparison

### 2. Use of the Fluorescent Glasses as a Mixing Component

The glass frits of Examples 1, 4 and 12 were ground to a particle size of 45-90 μm in a zirconia mill. Subsequently, the ground glass frits of Examples 1 and 4 were added to the non-fluorescent ground glass frit of Example 12 in different amounts (20, 33 and 50 wt.-% based on the mixture for the glass frit of Example 1; 33 and 50 wt.-% for the glass frit of Example 4) as a mixing component.

2.5 g of each of the powder mixtures was mixed with 1.6 μl of distilled water and pressed for 10 s at 25 bar by means of a hydraulic press to form powder compacts and then sintered at the temperatures T_{Sinter} and holding times t_{Sinter} given in Table II.

TABLE II

| Proportion of | Sintering conditions (T_{Sinter}, t_{Sinter}) | |
|---|---|---|
| mixing | Addition | Addition |
| component | Ex. 1 to Ex. 12 | Ex. 4 to Ex. 12 |
| 20 wt.-% | 750° C., 1 min | — |
| 33 wt.-% | 770° C., 1 min | 730° C., 1 min |
| 50 wt.-% | 770° C., 1 min | 750° C., 1 min |

After sintering, the fluorescence properties of the sintered powder compacts were investigated with a mercury vapor lamp (excitation wavelength 365 nm) and with a UV LED (excitation wavelength 395 nm). The sintered powder compacts showed clearly perceptible fluorescence both when irradiated with the mercury vapor lamp and with the UV LED. It was found that intense fluorescence can be obtained by using a high proportion of fluorescent mixing component.

### 3. Production of Sintered Powder Compacts

The glass frits of examples 1, 2 and 4 were ground to a particle size of 45-90 μm in a zirconium oxide mill. 2.5 g of each of the glass powders obtained were mixed with 1.6 μl distilled water and pressed into blanks for 10 s at 25 bar using a hydraulic press and sintered in a sintering furnace at a temperature T_{Sinter} and a holding time of t_{Sinter}.

The sintering conditions T_{Sinter} and t_{Sinter} used for the preparation of each blank are given in Table III.

TABLE III

| Glass frit from example | 1 | 2 | 4 |
|---|---|---|---|
| T_{Sinter} [° C.] | 730 | 760 | 800 |
| t_{Sinter} [min] | 1 | 1 | 1 |

The fluorescence of the obtained bodies was determined under a mercury vapor lamp (excitation wavelength 365 nm) and a UV LED (excitation wavelength 395 nm). All sintered glasses showed clearly perceptible fluorescence when irradiated with the mercury vapor lamp and also when irradiated with the UV LED.

1. A glass containing cerium and tin, which comprises the following components in the amounts indicated:

| Component | Wt. - % |
|---|---|
| SiO₂ | 38.0 to 68.0 |
| Cerium, calculated as CeO₂ | 4.0 to 23.0 |
| Tin, calculated as SnO | 3.0 to 18.0 |
| Li₂O | 1.0 to 5.0 |
| Alkali metal oxide Me^{I}₂O | 5.8 to 15.9 |
| Oxide of divalent elements Me^{II}O | 3.2 to 10.5 |
| Oxide of trivalent elements Me^{III}₂O₃ | 3.5 to 11.8, |

wherein
Me^{I}₂O is selected from Na₂O, K₂O, Rb₂O, and/or Cs₂O,
Me^{II}O is selected from MgO, CaO, SrO, BaO and/or ZnO,
Me^{III}₂O₃ is selected from Al₂O₃, B₂O₃, Y₂O₃, La₂O₃, Dy₂O₃, Ga₂O₃, and/or In₂O₃.

2. The glass according to claim 1, which comprises 4.3 to 22.0 wt.-% cerium, calculated as CeO₂.

3. The glass according to claim 1, which comprises 3.4 to 17.2 wt.-% tin, calculated as SnO.

4. The glass according to claim 1, wherein the molar ratio of cerium, calculated as CeO₂, to tin, calculated as SnO, is in the range of 1.5:1 to 1:1.5.

5. The glass according to claim 1, which comprises 1.4 to 4.0 wt.-% Li₂O.

6. Glass according to claim 1, which comprises 0.4 to 2.4 wt.-% fluorine.

7. Glass according to claim 1, which comprises at least one of the following alkali metal oxides in the amounts indicated:

| Component | Wt. - % |
|---|---|
| K₂O | 2.0 to 7.9 |
| Na₂O | 3.8 to 8.0. |

8. Glass according to claim 1, which comprises at least one of the following oxides of divalent elements Me^{II}O in the amounts indicated:

| Component | Wt. - % |
|---|---|
| CaO | 0.8 to 2.5 |
| SrO | 1.0 to 3.0 |
| ZnO | 1.4 to 4.0 |
| MgO | 0 to 1.0. |

9. Glass according to claim 1, which comprises at least one of the following oxides of trivalent elements in the amounts indicated:

| Component | Wt. - % |
|---|---|
| Al₂O₃ | 2.5 to 7.3 |
| B₂O₃ | 1.0 to 4.5. |

10. Glass according to claim 1, which comprises at least one of the following oxides of tetravalent elements Me^{IV}O₂ in the amounts indicated:

| Component | Wt. - % |
|---|---|
| TiO₂ | 0 to 2.2 |
| ZrO₂ | 0 to 1.2. |

11. Glass according to claim 1, which comprises oxide of pentavalent elements Me^{V2}O₅ in an amount of from 0 to 10.0 wt.-%, wherein this Me^{V2}O₅ is selected from P₂O₅, Ta₂O₅ and/or Nb₂O₅.

12. Glass according to claim 1, which comprises at least one of the following components in the amounts indicated:

| Component | Wt. - % |
|---|---|
| SiO₂ | 38.0 to 68.0 |
| Cerium, calculated as CeO₂ | 4.0 to 23.0 |
| Tin, calculated as SnO | 3.0 to 18.0 |
| Li₂O | 1.0 to 5.0 |
| Al₂O₃ | 2.5 to 7.3 |
| Na₂O | 3.8 to 8.0 |
| K₂O | 2.0 to 7.9 |
| CaO | 0.8 to 2.5 |
| SrO | 1.0 to 3.0 |
| ZnO | 1.4 to 4.0 |
| B₂O₃ | 1.0 to 4.5 |
| F | 0.4 to 2.4 |
| ZrO₂ | 0 to 1.2 |
| MgO | 0 to 1.4 |
| TiO₂ | 0 to 3.0. |

13. Glass and glass ceramic, which comprise the glass containing cerium and tin according to claim 1, in an amount of 0.1 to 60 wt.-%.

14. Process for preparing the glass according to claim 1, wherein the tin is used at least partially in divalent form.

15. Process according to claim 14, wherein the starting materials of the components of the glass are melted at a temperature of 1400° C. to 1700° C.

16. Process according to claim 15, wherein the starting materials of the components of the glass are melted at a temperature of 1400° C. to 1700° C. for 20 min to 10 h.

17. Process of using the glass according to claim 1, as a mixing component for adjusting the fluorescence of a glass or glass ceramic.

18. Process of using the glass according to claim 1 as a dental material for coating a dental restoration, wherein the glass is applied to a substrate material and subjected together with the substrate material to a heat treatment at a temperature of at least 600° C.

19. Process for coating a dental restoration, wherein the glass according to claim 1 is applied to a substrate material and subjected together with the substrate material to a heat treatment at a temperature of at least 600° C.
